(19) United States
(12) Patent Application Publication
(10) Pub. No.: US 2025/0277376 A1
(43) Pub. Date: Sep. 4, 2025

(54) METHOD FOR PREPARING A FOAMED FLOOR WITH WOOD TEXTURE

(71) Applicant: Anhui Sentai WPC Tec Flooring Co., Ltd., Anhui Province (CN)

(72) Inventors: Donghui Huang, Anhui Province (CN); Daoyuan Tang, Anhui Province (CN); Tangyong Dan, Anhui Province (CN)

(21) Appl. No.: 19/213,091

(22) Filed: May 20, 2025

Related U.S. Application Data
(62) Division of application No. 17/254,874, filed on Dec. 22, 2020.

(30) Foreign Application Priority Data
Oct. 24, 2019 (CN) 2019110167583

(51) Int. Cl. E04F 15/10; B29C 48/00; B29C 48/07; B29C 48/17; B29C 48/49; B29L 7/00; B32B 3/30; B32B 5/18; B32B 27/06; B32B 27/30; B44F 9/02

(52) U.S. Cl. CPC E04F 15/107; B29C 48/0012; B29C 48/002; B29C 48/0021; B29C 48/07; B29C 48/17; B29C 48/49; B32B 3/30; B32B 5/18; B32B 27/065; B32B 27/30; B44F 9/02; B29L 2007/001; B29L 2007/002; B32B 2266/0235; B32B 2307/404; B32B 2419/00

(57) ABSTRACT

The disclosure relates to a method for preparing a foamed floor with wood texture. It belongs to the technical field of co-extruded foam plate. The method of the present invention sequentially coats the foam matrix with a second surface layer formed from the first color resin and a first surface layer formed from the second color resin in layers. Subsequently, a portion of the first surface layer is pressed below the surface of the second surface layer using an embossing roller. Finally, the first surface layer is sanded away to expose the second surface layer. The disclosure uses resin as a material, is based on two surface layers, and realizes the realistic effect of wood texture through some levels of expressions such as three-dimensional (depth of texture), color difference, brightness etc. It can also realize a variety of wood textures by adjusting the three-dimensional, chromatic aberration, and brightness.

### CROSS-REFERENCE TO RELATED APPLICATIONS

This divisional application claims priority to U.S. patent application Ser. No. 17/254,874, filed Dec. 22, 2020, which is a national stage application of PCT International Application PCT/CN2019/119345, filed Nov. 19, 2019, which claims priority to Chinese Patent Application 2019110167583, filed Oct. 24, 2019; the contents of which are incorporated herein by reference in their entireties.

The Chinese patent application with Publication No.: CN102294812A discloses a polystyrene wood-like profile, which to a certain extent solves the problem of appearance defects of the plastic floor itself. The surface layer material and the core layer material are put into the auxiliary extruder and the main extruder respectively, and co-extruded into a mold, so that the surface layer material is coated on the core layer material. The surface layer material is high-impact polystyrene and contains flow masterbatch with good compatibility with high-impact polystyrene but different fluidity and dispersibility, and the core material is polystyrene micro-foamed plate. The surface of the co-extruded profile is embossed to produce a three-dimensional effect or other effects.

### BACKGROUND

Traditional wood-like floors are generally composite floors. Each of them is composed of MDF substrate, wood grain decorative paper, wear-resistant layer and balance layer at the bottom. However, since the MDF substrate is prone to mold and rot, and there is a fire risk, a floor with anti-mold and flame-retardant functions is urgently needed in the field. In this case, PVC foam floor has become a choice. However, the shape and appearance of the PVC foam floor do not meet the traditional requirements of people using it, resulting in its low added value and difficult to use in a large area of the market.

### SUMMARY OF THE DISCLOSURE

This method adopts color masterbatches of different substrate colors to make base color masterbatches and flow texture masterbatches respectively. The base color masterbatch has good fluidity and may be dispersed in the base styrene material to form a background color during processing. Flow texture masterbatch has a low melt index and poor dispersibility, it cannot be uniformly dispersed during processing and wood grain or other textures cannot be formed with the extrusion of the material. The base color and flow texture are prone to mutual fusion and cross-color in the adjacent interfaces. The wood-like texture of the co-extruded floor is quite different from the wood texture, and general users can easily distinguish the above-mentioned floor from the solid wood floor in appearance.

To solve the above-mentioned problems, the present disclosure provides a foamed co-extruded floor with the same appearance as wood texture.

The technical solutions of the present disclosure to solve the above problems are as follows:
a foamed floor with wood texture, comprising a foam matrix that is formed of resin and has a block structure, and
a hard surface layer integrally connected with the foam matrix and covering at least one surface thereof,
the hard surface layer comprising a first exposed surface that is formed by a first color resin and substantially parallel to a surface of the foam matrix, and
a second exposed surface formed by a second color resin;
a first distance from the second exposed surface to a surface covered by the foam matrix being smaller than a second distance that from the first exposed surface to the surface covered by the foam matrix; and
the first exposed surface being composed of a plurality of exposed units that are roughly on a same plane; the second exposed surface being composed of a plurality of sunken units, and
the plurality of exposed units being arranged alternately with the plurality of sunken units;
the hard surface layer also comprising a connecting unit between adjacent exposed unit and sunken unit;
the connecting unit comprising a connecting substrate formed of the first color resin and integrally connected to the first exposed surface, and
a connecting profile that is covering the connecting substrate and is formed of the second color resin and integrally connected to the second exposed surface; and,
the hard surface layer also comprising a base layer formed of the first color resin and integrally connected to the connecting substrate and covered by the second exposed surface; the first color resin and the second color resin having two colors that are different; and,
the exposed units and the sunken units of the hard surface layer are arranged at intervals to form the wood texture.

In the above technical solution of the present disclosure, the hard surface layer not only plays a role of protecting and restraining the foam matrix, but also the exposed units and the sunken units of the hard surface layer are arranged at intervals to form the wood texture. Because the first exposed surface and the second exposed surface are independent of each other and connected integrally, and they have different colors, combined with their different depths, a three-dimensional effect can be shown, and different brightness levels under light can be also shown. So the wood grain jointly expressed by the first exposed surface and the second exposed surface has a realistic effect. The wood texture formed based on this has multiple levels of expression, such as color, three-dimension, brightness, and does not affect each other at different levels of expression, and different objects of the same level of expression do not affect each other, not only the wood texture effect is realistic, a variety of wood textures can be also shown by adjusting multiple levels to better meet the needs of the market. The first exposed surface and the second exposed surface are independent of each other because there are layers between them; the integral connection is achieved since their interlayer connection is not realized by means such as glue.

In embodiments, the foam matrix of the floor may be made of PVC foam material, and the hard surface layer may be made of ASA non-foam material.

In an example, the thickness of the first exposed surface may be not less than 0.1 mm, and the thickness of the second exposed surface may be not less than 0.05 mm.

In an example, the density of the foamed floor with wood texture may be 0.6-1.0 g/cm³, and the surface hardness may be 60-90 Rockwell.

In an example, the foam matrix of the floor may be fed by the main extruder, and the first exposed surface formed by the first color resin, the connecting substrate and the base layer may be fed by an auxiliary extruder, the second exposed surface formed by the second color resin and the connecting profile may be fed by another auxiliary extruder.

Another object of the present disclosure is to provide a method for preparing the above-mentioned foamed floor with wood texture.

The method includes the following steps:
a, adding the raw materials and additives that constitute the foam matrix to the main extruder; the raw materials and their additives being melted and plasticized in the main extruder, entering the main runner of the mold, and being extruded from the die lip of the main runner, entering the foam cavity of the mold to form, then to form a foam matrix;
b, adding the raw materials and additives that constitute the first color resin to the first auxiliary extruder, and adding the raw materials and additives that constitute the second color resin to the second auxiliary extruder; melting and plasticizing the materials respectively in the first auxiliary extruder and the second auxiliary extruder, the materials respectively entering the first auxiliary runner and the second auxiliary runner of the mold, and the molten materials flowing out from the I-shaped mouth of the first auxiliary runner and the I-shaped mouth of the second auxiliary runner respectively through the lateral diffusion of the first auxiliary runner and the second auxiliary runner, so that the molten materials coat the foam matrix in layers, and are co-extruded from the die of the mold to form the floor precursor structure; The floor precursor structure has a foam matrix, a first surface layer and a second surface layer, and the second surface layer may be arranged between the first surface layer and the foam matrix;
c, cooling and molding the floor precursor structure;
d, heating the surface of the floor precursor structure after cooling and molding to at least soften the first surface layer;
e, pressing a part of the first surface layer below the surface of the second surface layer through the embossing process of the embossing roller, so that the first surface layer and the second surface layer together show the prior state of the wood texture;
f, sanding, so that the first surface layer that has not been pressed into the surface of the second surface layer may be worn out, and the corresponding part of the worn area presents the second surface layer; transforming the prior state of the wood texture into the wood texture.

In an example, in step d, when heating the surface, the temperature of the first surface layer may be controlled within 250° C.

In an example, in step d, when heating the surface, a tunnel oven may be adopted for heating, the temperature in the oven may be controlled at 150-250° C., and the time may be controlled at 3-20s.

In an example, in step e, during embossing process of the embossing roller, the embossing roller may be a cold roller.

In an example, in step f, when sanding, a sanding machine may be used.

The present disclosure adopts the layered co-extrusion method to co-extrude the surfaces of the two layers on the foam layer, and to press the surfaces of the two layers through the embossing roller to extrude the prior state of the wood texture; after process of the embossing roller, the floor surface forms some areas with different shades, the first surface layer of some areas is embossed below the second surface layer. The first surface layer can be removed by sanding, and the part of the first surface layer that is embossed below the second surface layer cannot be removed, so the second surface layer remains the second surface layer and part of the first surface layer together to form a wood texture, which has a realistic effect.

In sum, the present disclosure has the following beneficial effects:

The foamed floor with wood texture of the present disclosure uses resin as a material, based on two surface layers and through multiple levels of expressions, such as three-dimensional (depth of texture), chromatic aberration, and brightness, to realize the lifelike effect of wood texture. And it can also realize a variety of wood textures by adjusting the three-dimensional, chromatic aberration, and brightness.

### BRIEF DESCRIPTION OF DRAWINGS

FIG. 1 is a schematic diagram showing the floor precursor structure of the present disclosure;

FIG. 2 is a schematic diagram showing the co-extruded floor of the present disclosure;

FIG. 3 is a partial enlarged view of FIG. 2;

FIG. 4 is a schematic diagram showing the structure of the mold of the present disclosure;

FIG. 5 is a front view of the Plate A in FIG. 4;

FIG. 6 is a front view of Plate B in FIG. 4;

FIG. 7 is a front view of the Plate C in FIG. 4;

### DETAILED DESCRIPTION OF THE DISCLOSURE

In the figure, 1—first surface layer module, 2—second surface layer module, 3—main runner module; 4—baffle plate, 5—mold outlet; 10—first surface layer casting cavity, 20—second surface layer casting cavity; 21—the second surface layer feeding plate, 22—second surface layer forming plate; 100—first surface layer runner, 200—second surface layer runner; 101—material inlet of the first surface layer module; 201—material inlet of the second surface layer module; 202—material outlet of the second surface layer feeding plate; 203—material inlet of the second surface layer forming plate; 1000—foam matrix, 2000—hard surface layer, 2001—first exposed surface, 2002—second exposed surface, 2003—base layer, 2010—connecting substrate, 2020—connecting profile; 2001′—first surface layer, 2002′—second surface layer.

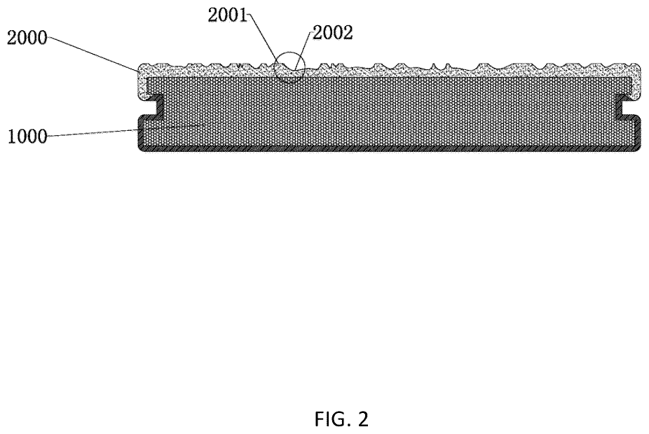

As shown in FIG. 2, a foamed floor with wood texture may include a foam matrix 1000 and a hard surface layer 2000. The hard surface layer 2000 may be a three-dimensional concave-convex structure where the convex surface may be a first exposed surface 2001, and the concave surface may be a second exposed surface 2002. The first exposed surface 2001 may be formed of a first color resin and may be substantially parallel to one surface of the foam matrix 1000. The second exposed surface 2002 may be formed of a second color resin. A certain color difference may be formed between the first color resin and the second color resin.

The first exposed surface 2001 may be composed of a plurality of exposed units substantially on the same plane, and the second exposed surface 2002 may be composed of a plurality of sunken units. The exposed units and the sunken units may be arranged alternately.

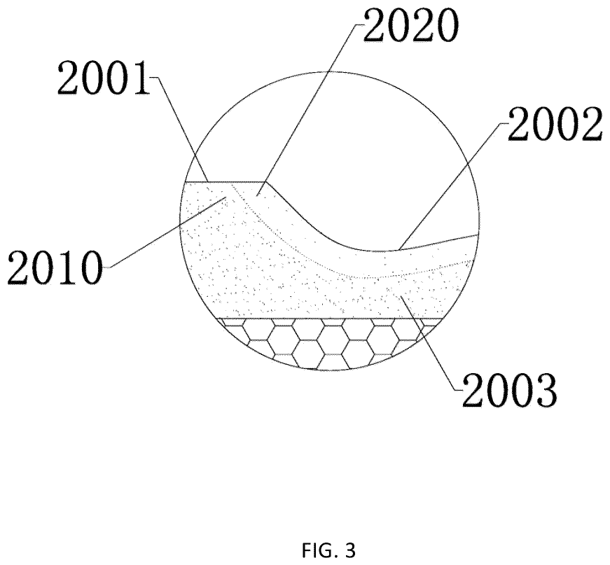

As shown in FIG. 3, a connecting unit may be provided between the adjacent exposed unit and the sunken unit, which may be a part of the hard surface layer 2000. The connecting unit may include a connecting substrate 2010 and a connecting profile 2020 that may be integrally connected. The connecting substrate 2010 may be formed of the first color resin and may be integrally connected with the first exposed surface; the connecting profile 2020 may cover the connecting substrate 2010 and may be formed of the second color resin.

The hard surface layer 2000 may further include a base layer 2003 that may be formed of the first color resin and may be integrally connected with the connecting substrate 2010, and covered by the second exposed surface 2002.

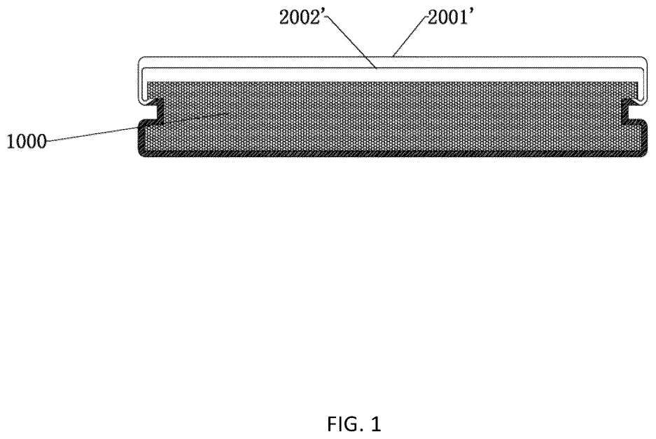

In the foamed floor with wood texture of this embodiment, the foam matrix 1000 may be made of PVC micro-foamed material, and the hard surface layer 2000 may be made of ASA. The thickness of the first exposed surface 2001 may be 0.2 mm, and the thickness of the second exposed surface 2002 may be 0.08 mm. The density may be 0.72 g/cm³, and the surface hardness may be 72 Rockwell. The manufacturing method of the above-mentioned foamed floor with wood texture may include the following steps:
a, adding the raw materials and additives that make up the foam matrix 1000 to the main extruder after mixing by a high-speed mixer; melting and plasticizing the raw materials and their additives in the main extruder and entering the main runner of the mold; extruding from the die lip of the main runner and entering the foaming cavity of the die to foam to form the foam matrix 1000;
b, adding the raw materials and additives that constitute the first color resin, and the raw materials and the additives that constitute the second color resin to the first auxiliary extruder and the second auxiliary extruder respectively after mixing by a high-speed mixer; melting and plasticizing the materials in the first auxiliary extruder and the second auxiliary extruder, respectively, then entering the first surface runner and the second surface runner of the mold; the molten material flowing out from the I-shaped mouths of the first surface runner and the second surface runner, respectively though through lateral diffusion of the first surface runner and the second surface runner, and entering the first surface casting cavity and the second surface casting cavity; the molten material coating the foam matrix 1000 in layers, and co-extruding from the die of the mold; air-cooling and shaping in the shaping mold after extrusion, and forming the floor precursor structure after shaping; As shown in FIG. 1, the floor precursor structure may have a foam layer 1000, a first surface layer 2001′ and a second surface layer 2002′;
c, water cooling and shaping the floor precursor structure;
d, heating the surface of the floor precursor structure after water cooling and shaping to make the first surface layer 2001′ and the second surface layer 2002′ soften; Specifically, through a tunnel heating oven, the temperature of the oven may be controlled at 200° C., with 10s of the time of the tunnel heating oven, the first surface layer 2001′ may be heated to about 90° C. to soften it and be suitable for embossing texture;
e, embossing though the embossing roller, to make a part of the first surface layer 2001′ pressed below the surface of the second surface layer 2002′, so that the first surface layer 2001′ and the second surface layer 2002′ together show the prior state of the wood texture;
f. sanding, so that the first surface layer 2001′ that has not been pressed into the surface of the second surface layer 2002′ may be worn out, and the corresponding part of the worn area presents the second surface layer 2002′; transforming the prior state of the wood texture into the wood texture.

In the above-mentioned technical solution of the embodiment, the raw materials and additives that constitute the foam matrix 1000, and the raw materials and the additives that constitute the hard surface layer 2000 belong to the prior art, so detailed descriptions may be omitted.

Based on the above preparation method, in the floor precursor structure, the second surface layer is positioned between the first surface layer and the foam matrix.

As shown in FIG. 3, in the floor structure:
the first exposed surface, the connecting substrate, and the base layer are formed by the first color resin;
the connecting profile and the second exposed surface are formed by the second color resin; and
after partial removal of the first surface layer, the second surface layer becomes the first exposed surface. Consequently, the second surface layer is formed by the first color resin, and the first surface layer is formed by the second color resin.

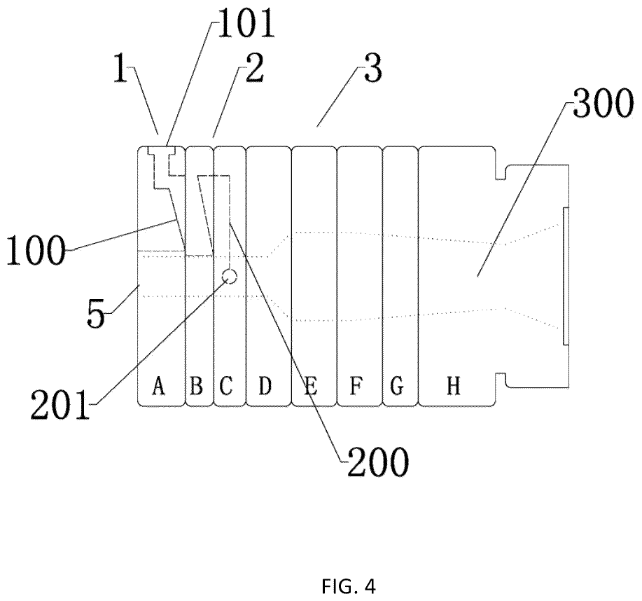

As shown in FIG. 4, a mold for manufacturing the above-mentioned foamed floor may include a main runner module 3, a second surface layer module 2 and a first surface layer module 1, consisting of eight runner plates A-H.

Among them, the plates D-H may be provided with the main runner 300 of the core layer of the mold, which may be used to form the core foam layer of the foamed co-extruded floor with wood-like texture.

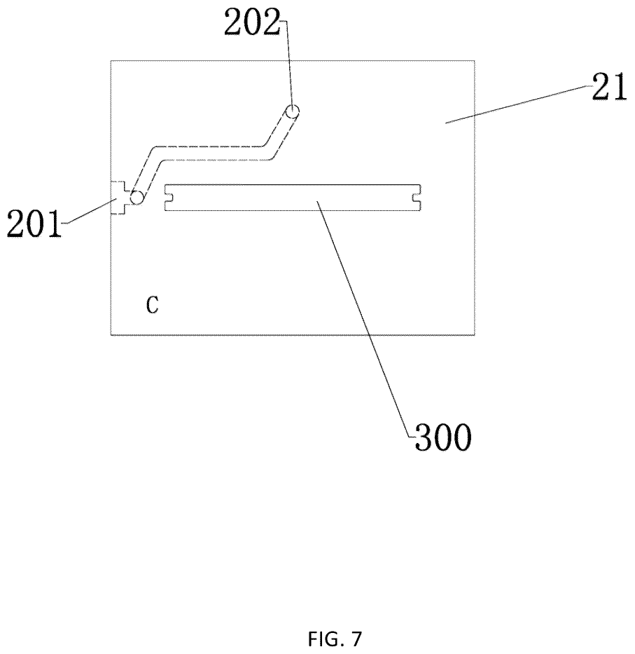

Also referring to FIG. 7, in addition to the main runner 300 of the mold core layer, the plate C may be also provided with a material inlet 201 of the second surface layer module and the material outlet 202 of the second surface layer feeding plate. The inlet and the outlet may be connected by a runner.

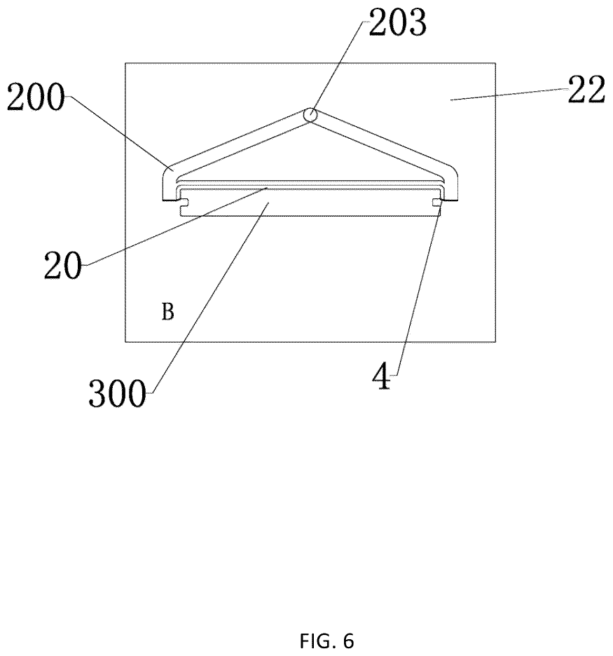

Also referring to FIG. 6, in addition to the main runner 300 of the mold core layer, the plate B may be also provided with a material inlet 203 of the second surface layer forming plate and a second surface layer runner 200. A second surface layer casting cavity 20 may be formed between the second surface layer runner 200 and the main runner 300. Baffle plates 4 may be also provided at both ends of the second surface layer casting cavity 20. The second surface layer runner 200 may be connected with the second surface layer casting cavity 20 through an I-shaped mouth. This arrangement can make the melt of the second surface layer covered on the core layer plate in a semi-covered manner to form the first intermediate.

The plate C may be the second surface layer feeding plate 21, and the plate B may be the second surface layer forming plate 22. The material outlet 202 of the second surface layer feeding plate may be connected to the material inlet 203 of the second surface layer forming plate. The second surface layer casting cavity 20 may be arranged on the second surface layer forming plate 22, and the material inlet 201 of the second surface layer module may be arranged on the side of the entire mold.

The plate B and the plate C together constitute the second surface layer module 2.

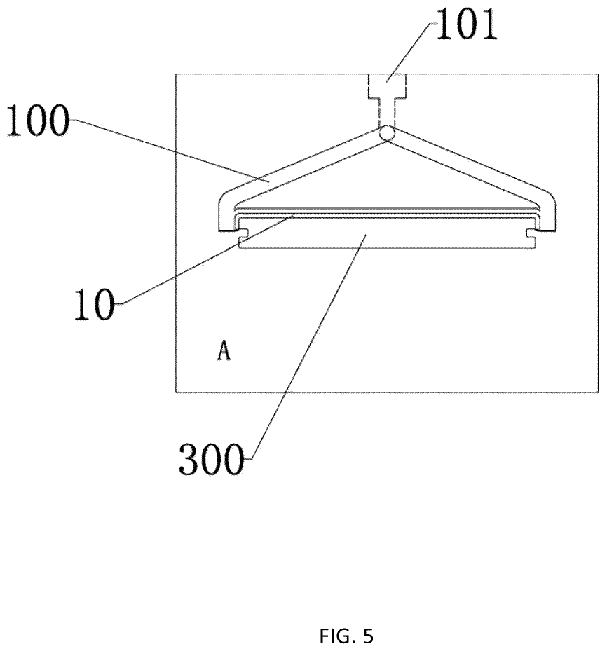

Also referring to FIG. 5, in addition to the main runner 300 of the mold core layer, the plate A may be also provided with a material inlet 101 of the first surface layer module and the first surface layer runner 100. A first surface casting cavity 10 may be formed between the first surface layer runner 100 and the main runner 300. Baffle plates 4 may be also provided at both ends of the first surface layer casting cavity 10. The first surface layer runner 100 and the first surface layer casting cavity 10 may be communicated with each other through an I-shaped mouth. This arrangement can make the melt of the first surface layer covered on the first intermediate in a semi-covered manner to form the precursor structure of the foamed floor with wood texture.

In this embodiment, the first surface layer module 1 may be solely composed of a runner plate, that is, the plate A. The material inlet 101 and the mold outlet 5 of the first surface layer module may be both arranged on the plate A, while the material inlet 101 of the first surface layer module may be arranged on the upper part of the mold.

In order to prevent cross-color between the first surface layer and the second surface layer, the distance between the material outlet of the first surface layer casting cavity 10 and the material outlet of the second surface layer casting cavity 20 in the die ejection direction may be not less than 0.1 mm.

After subsequent processing, the precursor structure of the foamed floor with wood texture can obtain the foamed floor with wood texture. The post-processing may be based on two surface layers. The Chinese disclosure application with publication No. CN102294812A has only one surface layer, so it may be relatively monotonous in terms of expression. For floors based on two surface layers, two surface layers can be processed separately, such as using different colors for the two surface layers, embossing the upper surface layer, and removing part of the surface layer after embossing to make the floor surface appear two levels of surface, from the perspective of three-dimensional (embossing depth), chromatic aberration, brightness, etc., a realistic effect of texture would be achieved.

1. A method for preparing a foamed floor with wood texture, the foamed floor with wood texture comprising a foam matrix that is formed of resin and has a block structure, and
a hard surface layer integrally connected with the foam matrix and covering at least one surface thereof,
the hard surface layer comprising a first exposed surface that is formed by a first color resin and substantially parallel to a surface of the foam matrix, and
a second exposed surface formed by a second color resin;
a first distance from the second exposed surface to a surface covered by the foam matrix being smaller than a second distance that from the first exposed surface to the surface covered by the foam matrix; and
the first exposed surface being composed of a plurality of exposed units that are roughly on a same plane; the second exposed surface being composed of a plurality of sunken units, and
the plurality of exposed units being arranged alternately with the plurality of sunken units;
the hard surface layer also comprising a connecting unit between adjacent exposed unit and sunken unit;
the connecting unit comprising a connecting substrate formed of the first color resin and integrally connected to the first exposed surface, and
a connecting profile that is covering the connecting substrate and is formed of the second color resin and integrally connected to the second exposed surface; and,
the hard surface layer also comprising a base layer formed of the first color resin and integrally connected to the connecting substrate and covered by the second exposed surface; the first color resin and the second color resin having two colors that are different; and,
the exposed units and the sunken units of the hard surface layer are arranged at intervals to form the wood texture;
comprising the following steps:
a, adding raw materials and additives thereof that constitute a foam matrix to a main extruder; melting and plasticizing the raw materials and additives thereof in the main extruder, entering a main runner of a mold, and being extruded from a die lip of the main runner; foaming in a foaming cavity of the mold to form the foam matrix;
b, adding the raw materials and additives thereof that constitute a first color resin to a first auxiliary extruder, and adding the raw materials and additives thereof that constitute a second color resin to a second auxiliary extruder; melting and plasticizing the materials respectively in the first auxiliary extruder and the second auxiliary extruder, respectively entering a first auxiliary runner and a second auxiliary runner of the mold, and molten materials flowing out from an I-shaped mouth of the first auxiliary runner and an I-shaped mouth of the second auxiliary runner though lateral diffusion of the first auxiliary runner and the second auxiliary runner, so that the molten materials coat the foam matrix in layers and extrudes from a die of the mold, to form a floor precursor structure; the floor precursor structure having the foam matrix, a first surface layer and a second surface layer, the second surface layer being set between the first surface layer and the foam matrix;
c, cooling and shaping the floor precursor structure;
d, heating a surface of the floor precursor structure after cooling and shaping to at least make the first surface layer soft;
e, embossing through an embossing roller, such that a part of the first surface layer is pressed into a surface of the second surface layer, making the first surface layer and the second surface layer together show a prior state of the wood texture;
f, sanding to make the first surface layer that has not been pressed into the surface of the second surface layer is worn, and a corresponding part of worn area shows the second surface layer; transforming the prior state of wood texture into wood texture.

2. The method for preparing the foamed floor with wood texture according to claim 1, wherein: in step d, when heating a surface, a temperature of the first surface layer is controlled to be within 250° C.

3. The method for preparing a foamed floor with wood texture according to claim 1, wherein: in step d, when heating a surface, a tunnel oven is used for heating, and the temperature in the oven is controlled at 150˜250° C., the time is controlled within 3˜20s.

4. The method for preparing a foamed floor with wood texture according to claim 1, wherein: in step e, when embossing through an embossing roller, the embossing roller is a cold roller.

5. The method for preparing a foamed floor with wood texture according to claim 1, wherein: in step f, when sanding, a sanding machine is adopted.
